(19) United States
(12) Patent Application Publication
(10) Pub. No.: US 2008/0308690 A1
(43) Pub. Date: Dec. 18, 2008

(54) Artificial Mold, Artificial Decorative Lamp and Method of Making Artificial Decoration Lamp

(76) Inventor: Xuliang Li, Dongguan (CN)

Correspondence Address: GLOBAL IP SERVICES, 7285 W. Eagle Court, Winton, CA, 95388, US

(21) Appl. No.: 11/949,276

(22) Filed: Dec. 3, 2007

(30) Foreign Application Priority Data
Jun. 18, 2007 (CN) 200710075061.4

(51) Int. Cl. F16M 11/00

(52) U.S. Cl. 248/175

(57) ABSTRACT

The present invention relates to an artificial mold, an artificial decorative lamp and a method of making artificial decorative lamp. The artificial mold comprises framework of the mold, and the framework is covered by strips in the shape of spring, and strips in the shape of spring fix to the framework. An artificial decoration lamp comprises luminous body and artificial mold, and the artificial mold comprises framework of mold. The framework is covered by strips in the shape of spring, and strips in the shape of spring fix to the framework; luminous body is mounted on the artificial mold. A method of making an artificial decoration lamp, comprising following steps: tinsel is weld to configure framework of mold, and tinsel is screwed or spun into strips in the shape of spring; semi finished article of artificial mold is formed by covering said framework with said strips in the shape of spring, by the way of welding; the surface of said semi finished article of artificial mold, made in the second step, is paint; golden powder or reflecting pieces are affixed on exterior semi finished article of artificial mold; LED strings are mounted in the artificial mold.

### CROSS REFERENCE TO RELATED PATENT APPLICATION

This application claims the priority of the Chinese patent application No. 200710075061.4 having a filing date of Jun. 18, 2007.

### FIELD OF THE INVENTION

The present utility mold relates to ornaments, and more particularly to artificial molds, artificial decorative lamps and a method of making the artificial decorative lamp.

### BACKGROUND OF THE INVENTION

Mold and mold decorative lamp are widely used in daily life. Normal mold and mold decorative lamp comprise framework, luminous body (such as LED lamp) installed in the framework (for example, by the way of trussing), and a layer of gauze or film set on the surface of the framework. Design may be printed on the film, such as the decorative lamp disclosed in Chinese patent 200620153799.4. Mold and mold decorative lamp of prior art are not so vivid, moreover, they cannot achieve golden effect to foil the special atmosphere.

### SUMMARY OF THE INVENTION

One object of the invention is to overcome the drawbacks of the prior art, to provide vivid and golden artificial molds, artificial decorative lamps of the same and a method of making the artificial decorative lamp.

To achieve the above-mentioned object, the present invention comprises:

An artificial mold, comprising a framework and the framework is covered by strips in the shape of spring, while the strips in the shape of spring form the exterior of said framework. The artificial mold is composed by the strips in the shape of spring and the framework together, and the strips in the shape of spring fix to the framework.

The framework and the strips in the shape of spring are both made of metal. The strips in the shape of spring are welded in the framework. The strips in the shape of spring and the surface of the framework are paint, and golden powder or reflecting pieces are affixed on exterior of the paint.

The framework is in the shape of Christmas tree, snow man, deer or house. The strips in the shape of spring are parallel set as net.

An artificial decorative lamp comprises luminous body and artificial framework, wherein the artificial mold comprises framework, and the framework is covered by strips in the shape of spring, while the strips in the shape of spring form the exterior of the framework. The artificial mold is composed by the strips in the shape of spring and the framework together, and the strips in the shape of spring fix to the framework. Luminous body is mounted in the framework.

The framework and the trips in the shape of spring are both made of metal and the strips in the shape of spring are welded in the framework. The strips in the shape of spring and the surface of the framework are paint, and golden powder or reflecting pieces are affixed on exterior of the paint. The luminous body is LED lamp, and the LED lamp connects to lamp holder of LED by lead to form LED strings.

The LED strings are mounted in the interior of the cavum surrounded by the trips in the shape of spring.

The LED strings are mounted on the exterior of the framework.

A method of making an artificial decoration lamp comprises following steps:

First, tinsel is weld to configure framework of mold, and tinsel is screwed or spun into strips in the shape of spring.

Second, semi finished article of artificial mold is formed by covering the framework with the strips in the shape of spring, by the way of welding.

Third, the surface of the semi finished article of artificial mold, made in the second step, is paint.

Fourth, golden powder or reflecting pieces are affixed on exterior the semi finished article of artificial mold made in the third step.

Fifth, LED strings are mounted in the artificial mold made in the fourth step.

An artificial mold comprises framework, wherein the framework is covered with strip locks made of several loop chains, and bare cavity is surrounded by the strip locks, while exterior of the artificial mold is formed by the strip locks. The artificial mold is composed by the strip locks and the framework together, and the strip locks fix to the framework.

An artificial decoration lamp comprises luminous body and artificial mold, wherein the artificial mold comprises framework, the framework is covered with strip locks made of several loop chains, and bare cavity is surrounded by the strip locks, while exterior of the artificial mold is formed by the strip locks. The artificial mold is composed by the strip locks and the framework together, and the strip locks fix to the framework, luminous body is mounted in the artificial mold.

Framework of artificial mold the present invention relates to is covered by strips in the shape of spring, while the strips in the shape of spring formed bare cavity, and the strips in the shape of spring formed exterior of artificial mold. The artificial mold is composed by the strips in the shape of spring and the framework together. Because the strips in the shape of spring are surrounded on the exterior of the framework, they are non-light tight, and fully externalize the mold, thus make the artificial mold vivid. While the framework and strips in the shape of spring are made of metal, surface of strips in the shape of metal and framework may be painted, and exterior of paint may be affixed by golden power or reflecting pieces, to achieve golden effect, which can foil atmosphere.

The artificial decoration lamp made by mounting luminous body in the above-mentioned artificial mold is much more vivid, because light reflects on the artificial mold, which even more gives prominence to golden effect.

The strips in the shape of spring in above-mentioned artificial mold and artificial decoration lamp may be substituted by strip locks made by several loop chains, which belongs to the same invention concept, and can gained the same effective.

The present invention relates to a method of making artificial decorative lamp, comprising technical of welding, painting and sticking, which is easy and feasible. The method is adapt to individual piece or mass manufacturing, and to manufacturing the above-mentioned artificial decoration lamp.

### BRIEF DESCRIPTION OF THE DRAWINGS

FIG. 1 is a perspective view of the strip in the shape of spring in the first embodiment of the present invention.

FIG. 2 is a perspective view of the first embodiment of the present invention.

FIG. 3 is flow program of the method of making artificial decoration lamp that the third embodiment of the present invention relates to.

### DETAILED DESCRIPTION OF THE INVENTION

The present invention will become more obvious from the following description when taken in connection with the accompanying drawings.

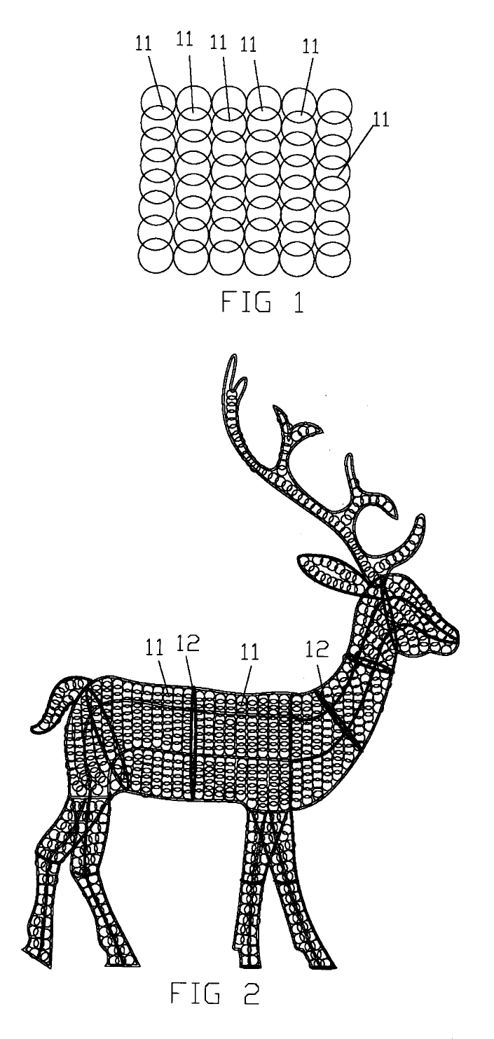

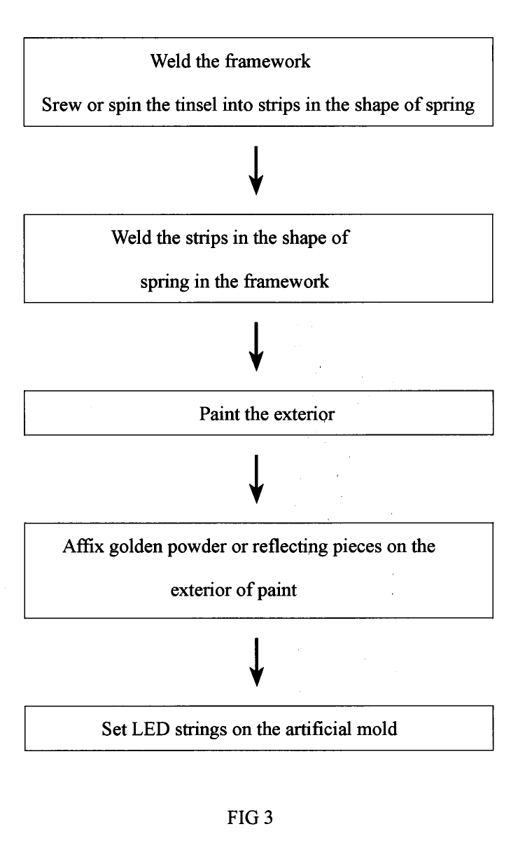

Referring to FIG. 1 and FIG. 2, the first embodiment of the present invention is an artificial mold in the shape of deer, comprising framework 12, wherein framework 12 is covered with strips in the shape of spring 11, and bare cavity is surrounded by the strips in the shape of spring 11, while exterior of the artificial mold is formed by strips in the shape of spring 11. The artificial mold is composed by the strips in the shape of spring 11 and the framework 12 together, and strips in the shape of spring 11 fix to the framework 12. The framework 12 is made of iron, and the strips in the shape of spring 11 are also made of iron, and the strips in the shape of spring 11 are welded in the framework 12. Strips in the shape of spring 11 and the surface of framework 12 are paint, and golden powder or reflecting pieces are affixed on exterior of paint. Referring to FIG. 1, in this embodiment strips in the shape of spring 11 may be set as net in pieces side by side, then cover the framework 12.

The second embodiment of the present invention is formed by mounting LED strings in the base of the first embodiment. LED strings are mounted on the exterior of the artificial mold, and LED strings are trussed on the exterior of artificial mold by EVA binding.

Referring to FIG. 2, the third embodiment of the present invention is a method of making artificial decorative lamp:

First, tinsel is weld to configure framework of mold, and tinsel is screwed or spun into strips in the shape of spring.

Second, semi finished article of artificial mold is formed by covering the framework with the strips in the shape of spring, by the way of welding.

Third, the surface of the semi finished article of artificial mold, made in the second step, is paint.

Fourth, golden powder or reflecting pieces are affixed on exterior the semi finished article of artificial mold made in the third step.

Fifth, LED strings are mounted in the artificial mold made in the fourth step.

Other technical schemes of the present invention can be achieved according to the content of claims and the above-mentioned embodiment, thus the other embodiments are omitted here.

While the invention has been described in connection with what is presently considered to be the most practical and preferred embodiment, it is to be understood that the invention is not to be limited to the disclosed embodiments, but on the contrary, is intended to cover various modifications and equivalent arrangements about the shape of the framework and the shape of cover mass of the framework.

What is claimed is:

1. An artificial mold, comprising framework, wherein said framework is covered by strips in the shape of spring, while said strips in the shape of spring form the exterior of said framework, and said artificial mold is composed by said strips in the shape of spring and said framework together, and said strips in the shape of spring fix to said framework.

2. The artificial mold according to claim 1, wherein said framework and said strips in the shape of spring are both made of metal, while said strips in the shape of spring are welded in said framework; said strips in the shape of spring and the surface of said framework are paint, and golden powder or reflecting pieces are affixed on exterior of said paint.

3. The artificial mold according to claim 1, wherein said framework is in the shape of Christmas tree, snow man, deer or house, and said strips in the shape of spring are parallel set as net.

4. An artificial mold according to claim 1, wherein a luminous body is mounted in said framework, thereby said artificial mold becomes an artificial decorative lamp.

5. An artificial mold according to claim 4, wherein said framework and said trips in the shape of spring are both made of metal, and said strips in the shape of spring are welded in the framework; said strips in the shape of spring and the surface of said framework are paint, and golden powder or reflecting pieces are affixed on exterior of said paint; said luminous body is made by LED lamps; said LED lamps connect to lamp holders of LED by lead to form LED strings.

6. An artificial mold according to claim 5, wherein said LED strings are mounted in the interior of the cavum surrounded by said trips in the shape of spring.

7. An artificial mold according to claim 5, wherein said LED strings are mounted on the exterior of said framework.

8. A method of making an artificial decoration lamp, wherein comprising following steps:
First, tinsel is weld to configure a framework of mold, and tinsel is screwed or spun into strips in the shape of spring;
Second, semi finished article of artificial mold is formed by covering said framework with said strips in the shape of spring, by the way of welding;
Third, the surface of said semi finished article of artificial mold, made in the second step, is paint;
Fourth, golden powder or reflecting pieces are affixed on exterior said semi finished article of artificial mold made in the third step;
Fifth, LED strings are mounted in the artificial mold made in the fourth step.

9. An artificial mold, comprising framework, wherein said framework is covered with strip locks made of several loop chains, and a bare cavity is surrounded by said strip locks, while exterior of said artificial mold is formed by said strip locks, while said artificial mold is composed by said strip locks and said framework together, and said strip locks fix to said framework.

10. An artificial mold according to claim 9, wherein a luminous body is mounted in said artificial mold, thereby the artificial mold becomes an artificial decoration lamp.
